(19) United States
(12) Patent Application Publication
(10) Pub. No.: US 2012/0296492 A1
(43) Pub. Date: Nov. 22, 2012

(54) Methods and Systems for Aggregating and Implementing Preferences for Vehicle-Based Operations of Multiple Vehicle Occupants

(75) Inventors: Oleg Yurievitch Gusikhin, West Bloomfield, MI (US); Mark Schunder, Dearborn, MI (US); Perry Robinson MacNeille, Lathrup Village, MI (US)

(73) Assignee: FORD GLOBAL TECHNOLOGIES, LLC, Dearborn, MI (US)

(21) Appl. No.: 13/111,455

(22) Filed: May 19, 2011

(51) Int. Cl. G06F 7/00

(52) U.S. Cl. 701/1

(57) ABSTRACT

A method and system may include aggregating and implementing preferences associated with vehicle occupants for vehicle-based operations. The occupants may be identified in a vehicle, each occupant having one or more preferences relating to a plurality of vehicle-based operations. The common preferences between the vehicle occupants may be identified, merged, and implemented in a vehicle.

### TECHNICAL FIELD

The various embodiments relate to implementing preferences for vehicle-based operations defined by multiple vehicle occupants.

### BACKGROUND ART

Various examples exist of tools which identify media preferences of vehicle occupants. Typically, aggregation of such preferences between multiple occupants is subject to a social principle called Arrow's paradox.

For example, U.S. Publication No. 2010/0228803 to Quinn discloses methods and systems for merging media. The method includes obtaining a first input from a first media device. The first input comprises first data corresponding to properties of one or more first media files. The method also includes obtaining a second input from a second media device. The second input comprises second data corresponding to properties of one or more second media files. A merged list is generated comprising one or more first selected media files of the first media files sharing a common property with at least one of the second media files and second selected media files of the second media files sharing the common property. The method also includes causing execution of one of the first selected media files, one of the second selected media files, or both.

### SUMMARY

One aspect includes a computer system for providing shared preferences between vehicle occupants for vehicle-based operations in a vehicle. The system may include at least one vehicle-based computer. The vehicle-based computer may be configured to receive information identifying two or more occupants in a vehicle. Each occupant may have one or more preferences relating to a plurality of vehicle-based operations. The vehicle-based computer may be further configured to identify the two or more occupants in a vehicle. Further, the vehicle-based computer may be configured to receive one or more common preferences between the two or more vehicle occupants relating to the plurality of vehicle-based operations. The common preferences may be identified based on a search of one or more data storage systems storing the preferences for each vehicle occupant. The vehicle-based computer may be further configured to implement the one or more identified common preferences in the vehicle.

Another aspect may include a computer-program product for providing shared preferences in a vehicle between vehicle occupants for vehicle-based operations. The computer-program product may include instructions for receiving information identifying a number of occupants in a vehicle. Each occupant may have one or more preferences relating to a plurality of vehicle-based operations. Based on the identified number of occupants, the computer program product may further include instructions for identifying the preferences relating to the plurality of vehicle-based operations for a single occupant or a plurality of occupants.

If there is a single occupant, there may be instructions for receiving the preferences for the single occupant. If there is a plurality of occupants, instructions may be include for receiving one or more common preferences between the plurality of vehicle occupants relating to the plurality of vehicle-based operations.

The computer program product may include instructions for preparing the one or more identified preferences for implementation at one or more vehicle-based systems.

Another aspect may include a method which includes receiving information at one or more computers that two or more occupants are in a vehicle. The method may also include receiving at the computer(s) preferences relating to a plurality of vehicle-based operations for each vehicle occupant. A presence of common preferences may be determined between each occupant relating to the plurality of vehicle-based operations. Further, the common preferences may be identified and prepared for implementation in the vehicle.

In some embodiments, the common preferences may be merged between the two or more vehicle occupants for implementation in the vehicle.

These and other aspects will be better understood in view of the attached drawings and following detailed description of the invention.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 illustrates a block topology of a vehicle computing system;

FIG. 2 illustrates various embodiments of a system configuration for a software module for aggregating preferences of vehicle occupants for vehicle-based operations;

FIG. 3A illustrates a process for creating and/or modifying vehicle occupant profiles;

FIG. 3B illustrates a process for configuring preferences of one or more vehicle occupants for vehicle-based operations;

FIG. 4 illustrates a process for implementing preferences for vehicle-based operations shared by all vehicle occupants;

FIG. 5 illustrates a process for aggregating vehicle-based operations preferences shared by multiple vehicle occupants; and

FIG. 6 illustrates a process for filtering preferences based on categories of preferences.

### DETAILED DESCRIPTION

Whether travelling with friends or family, finding common preferences in, for example, music, cabin temperature, and navigation routes can be challenging. After a few minutes (or longer) of discussion and, possibly, argument, some consensus may be found among the group. During a long car ride, such a scenario may occur multiple times. With the advent of technology, such as in-vehicle connectivity systems, such challenges may be avoided or, at least, minimized.

Detailed embodiments of the invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

Additionally, the disclosure and arrangement of the figures is non-limiting. Accordingly, the disclosure and arrangement of the figures may be modified or re-arranged to best fit a particular implementation of the various embodiments of the invention.

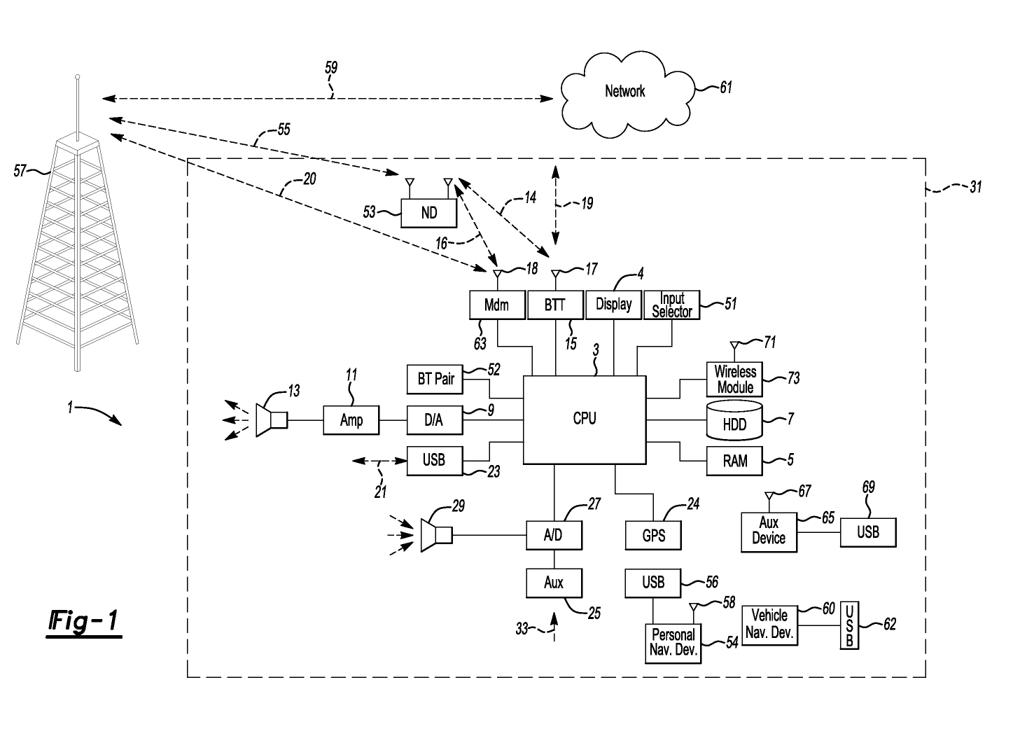

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), a network operating according to IEEE 802 LAN/MAN standards (e.g., and without limitation WiFi or WiMax).

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

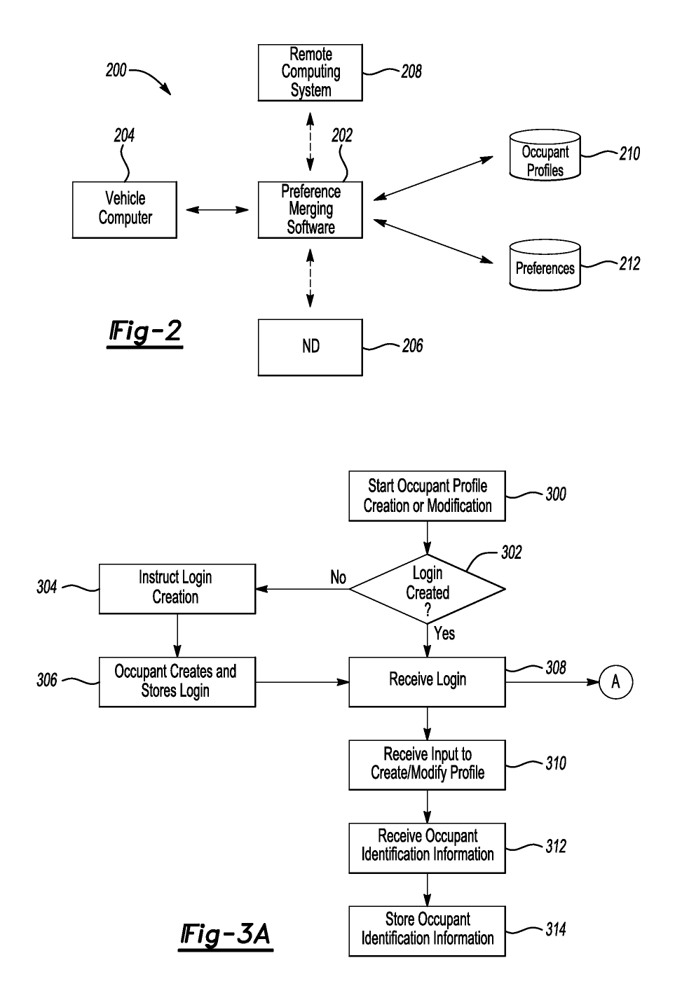

FIG. 2 illustrates various embodiments of a system architecture for merging (also referred to herein as “aggregating”) shared configuration preferences between vehicle occupants for one or more vehicle-based operations. The steps and process for merging shared configured preferences may be performed by a computer program product 202 installed on and executing from one or more computing devices in the system 200. The computer program product 202 may be a software module or software application installed to and executing from the computing device. The process will be described in further detail below.

In one embodiment, the computer program 202 may be executing on the CPU 3 (referred to in FIG. 2 as vehicle computer 204). In some embodiments, the computer program 202 may be downloaded to the vehicle computer 204 from remote memory storing the computer program 202 (not shown). The memory may be a portable storage device (e.g., a USB stick, a flashcard, memory stick, and the like) and/or a remote terminal configured to communicate with the vehicle computer 204 via an Internet connection. In some embodiments, the remote terminal may be a third-party system, such as an application store.

In another embodiment, the computer program 202 may be executing on the ND 206 (corresponding to ND 53 in FIG. 1). In some embodiments, the computer program 202 may be downloaded to the ND 206 from memory. The download process is described above and, therefore, not repeated for purposes of brevity.

In another embodiment, the computer program 202 may be executing on a remote computing system 208. The remote system 208 may be one or more computer servers. In this embodiment, information may be exchanged wirelessly between the remote system 208 and the VCS 1 using data-over-voice, the Internet, or other like communication described above. Further, an application programming interface (API) may be stored in memory of the VCS 1 or the ND 53 for interfacing with the remote system 208. The information exchanged between the VCS 1 and the remote system 208 may be exchanged via the API. This embodiment may represent one non-limiting example of the VACS described above.

For purposes of brevity, and not limitation, the various embodiments will be described and illustrated herein in the context of the computer program 202 executing on the vehicle computer 204.

Occupant profiles 210 and vehicle-based operations preferences 212 may be stored in memory of one or more computers. The computer memory 210, 212 may be running remotely (e.g., at remote computing system 208) or locally (e.g., at VCS 1 or ND 206). The computer memory 210, 212 may be non-volatile memory. In some embodiments, the profile information 210 and preferences 212 may be stored in and accessed from one or more databases. In other embodiments, the occupant profile information 210 and the preferences 212 information may be stored separately, but associated with each other. For purposes of illustration, the profile information 210 and the preference information 210 are illustrated as separate storage systems.

The occupant profile 210 may store information about one or more users or vehicle occupants. As used herein, vehicle occupants may refer to a user of the system who may be an occupant in a vehicle. The information may include identification information of the vehicle occupants. Non-limiting and non-exhaustive examples of identification information may include a mobile identification number (MIN), a name, a fingerprint, a voiceprint, a unique keyphrase, a unique code (numeric, alphabetic, or alphanumeric), a unique graphic, or combination of such identification information. Of course, the occupant profile 210 may include other information about the vehicle occupants, but for brevity, are not disclosed.

In some embodiments, the identification information may include an electronic mail address of a vehicle occupant. The use of an electronic mail address to identify a vehicle occupant will be described below.

Merging shared preferences for vehicle-based operations may be performed for vehicle occupants that are subscribed members of a service. Aggregation of shared preferences may be a service for which vehicle occupants may register or to which they may subscribe. Accordingly, the service may be stand-alone or a service associated with a consumer-interfacing application (e.g., an application relating to music, navigation, information, or the like). As a non-limiting example of the latter, two or more vehicle occupants may be registered users of an Internet radio application such as PANDORA. The music preferences for two or more vehicle occupants who are registered users of the Internet radio service may be merged and played from the VCS 1. It will be appreciated that that the service may or may not be a third-party service.

Once a vehicle occupant is registered as a member, the identification information associated with the vehicle occupant (as provided by the vehicle occupant) may be stored as occupant profile information 210. When in a vehicle, the preferences of registered members may be aggregated as described in the various embodiments herein.

In some embodiments, preferences may be merged for members of the service who are connected as through a social network. Said differently, in this case, the preferences of a vehicle occupant will not be merged with the preferences of another vehicle occupant if the vehicle occupants are not a member of each other's social network.

In some embodiments, vehicle occupants may be in a shared network solely for the purpose of sharing preferences. This may be an “opt-in” feature for each occupant entered by the occupants from the vehicle computer and/or the ND.

The occupant profile information 210 may be stored with each service (e.g., and without limitation, occupant profiles for an Internet radio application or an occupant profile for a navigation application). Alternatively or additionally, the occupant profiles may be stored in a central system such that the occupant profiles are associated and available for all services to which the vehicle occupant subscribes.

In some embodiments, a vehicle occupant may grant various levels of access to their profile to other vehicle occupants. Some occupants may have greater access to the profile than others. A vehicle occupant may grant access to their profile to another so that, as a non-limiting example, preference may be compared.

The preferences 212 may include the vehicle occupant's configuration preferences for one or more vehicle vehicle-based operations. The preferences may be established by the vehicle occupant and stored in the preferences storage system 212. Non-limiting and non-exhaustive examples of vehicle-based operations for which preferences may be established may include navigation routes, points-of-interest (POI), HVAC settings, media preferences (including, but not limited to, genres, artists, and radio stations), vehicle speed, information sources (e.g., news and traffic), sources of RSS feeds, cabin lighting, travel schedules (e.g., time of arrival, departure, or both), and others. Details of the process for establishing preferences for vehicle-based operations will be described below.

Specific preferences for the vehicle-based operations may be established by the vehicle occupant. For example, the vehicle occupant may store specific genres of music for listening (e.g., from a radio or media device in the vehicle). As another example, the vehicle occupant may store one or more preferred types of routes (e.g., no toll roads, highways only, etc.). As another example, the vehicle occupant may store one or more preferred cabin climate settings. Specific preferences may be set for all vehicle-based operations or for select vehicle-based operations. It will be appreciated that, as referred to herein, the preferences for vehicle-based operations may be preferences that relate directly to the vehicle-based operation(s) (e.g., cabin climate or navigation, etc.) and/or preferences that effect vehicle-based operation(s). As a non-limiting example of the latter, a vehicle occupant may have diet restrictions. As such, the navigation system may only display restaurants along a route based on the dietary restriction. As another non-limiting example, a media genre preference may affect the radio stations that are played or the media played from a paired media device.

Additionally, the configuration preferences for each vehicle-based operation may be further configured based on time-based preferences and weather-based preferences. As a non-limiting example of a time-based preference, a preference may be set for operation times of certain vehicle-based operations (e.g., and without limitation, play a preferred news radio station on weekdays between 8-9 AM). The time-based preferences may relate to specific times and/or periods of time (e.g., daily, weekly, monthly, and variations thereof). The time may be determined from a vehicle clock, a clock on the ND, a GPS clock, a crystal oscillator, or other like time-detecting device.

As a non-limiting example of a weather-based preference, a preference may be set to turn on the vehicle heat and, in some embodiments, to a particular temperature or temperature range, when the cabin and/or outside temperature falls below a particular threshold. Similarly, a preference may be set to turn on the air conditioning and, in some embodiments, to a particular temperature or temperature range, when the cabin and/or outside temperature is above a threshold. As another non-limiting example, a preference may be set to avoid backroads (to the extent possible) in generating a navigation route when inclement weather (e.g., a blizzard) is detected. The weather conditions may be determined based on information from one or more vehicle sensors used for weather/temperature detection.

In some embodiments, the software 202 may provide information to potentially arrange a carpool based on shared preferences relating to travel schedules and/or travel routes. Further details of this process will be described below.

The configurations preferences may be based on one or more levels or rankings of acceptability for the vehicle-based operations. As a non-limiting example, the vehicle occupant may define preferences for the vehicle-based operations using levels of acceptability such as “like,” “tolerate,” and “dislike.” Of course, the terminology and number of categories are provided as examples and, therefore, are non-limiting. In some embodiments, the levels of acceptability may be provided numerically or alphabetically based on, for example, a numerical or alphabetic scale, respectively. Further details of the operation of the categories within the context of the various embodiments will be described below with respect to FIG. 6.

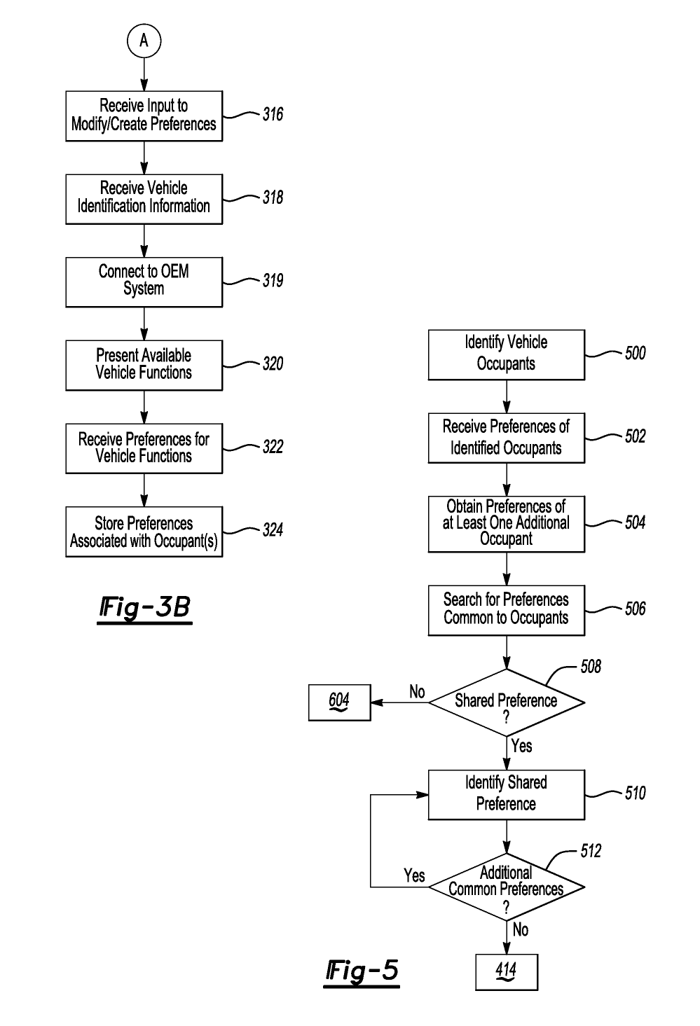

As described above, the occupant profiles 210 and the preferences 212 for the vehicle occupants may be established by the vehicle occupants. FIG. 3A illustrates a process for establishing an occupant profile. At any time, the vehicle occupant may modify a profile. Accordingly, FIG. 3A also illustrates a process for modifying the occupant profile.

Occupant profile creation and/or modification may be performed using the software 202 executing in memory. Additionally or alternatively, the occupant profile may be created/modified using a website accessed from the ND 53, the VCS 1, or a PC (not shown). The execution of the software and/or visiting the website may start the occupant profile creation/modification process (block 300)

A login may be created by the vehicle occupant. If, for example, the vehicle occupant does not have a login (block 302), the vehicle occupant may be instructed to create the login (block 304). The vehicle occupant may create the login which may be stored in the occupant profile system 210 (block 306). Login information may be a username and password. Other forms of login may be used without departing from the scope of the invention such as (and without limitation) biometric information. After a login is created (block 302), the login may be received from the vehicle occupant (block 308).

After the occupant has logged-in, instructions may be provided by the vehicle occupant to create and/or modify the profile (block 310) or to create/modify the preferences (as represented by circle block A). Creation/modification of the preferences will be described with respect to FIG. 3B. The instructions may be received in the form of input via one or more mouse clicks, keyboard or keypad button presses, voice inputs, touchscreen presses, and the like.

The vehicle occupant may provide the profile information which may be received via one or more input devices (block 312) and stored (block 314) into memory 210. Non-limiting examples of profile information that may be received is provided above. The one or more input devices through which the profile information may be received may include, but are not limited to, a keyboard, a keypad, a touchscreen, a microphone, a fingerprint scanner, a mouse, and other like peripherals.

Continuing to FIG. 3B, as represented by circle block A, the vehicle occupant may additionally or alternatively create/modify preferences for the vehicle-based operations. Accordingly, instructions may be received to create/modify preferences (block 316). The instructions may be received in the form of input via one or more mouse clicks, keyboard or keypad button presses, voice inputs, touchscreen presses, and the like.

The preferences for vehicle-based operations may be received via one or more input devices. Through a user interface, the vehicle occupant may input one or more preferences for various types of vehicle-based operations of which some non-limiting examples are provided above.

In some embodiments, the user may be provided with which vehicle-based operations are available in a vehicle and, based on this information, may input the one or more preferences. In order to do so, vehicle identification information may be received to identify the vehicle (block 318). Information relating to the available vehicle-based operations in a vehicle may be maintained remotely by the vehicle manufacturer (OEM). Accordingly, as represented by block 319, the process may include connecting to an OEM system with vehicle information records (not shown). Based on the vehicle identification information, the vehicle-based operations available in the vehicle may be received from the OEM system and presented to the vehicle occupant (block 320).

The preferences may be received from the vehicle occupant for one or more vehicle-based operations (block 322). The preferences may be stored in the preference storage system 212 and associated with the respective vehicle occupant (block 324).

FIG. 4 illustrates a process for implementing shared preferences among all vehicle occupants. The software 202 may be started (block 400) to perform the aggregation of shared preferences. The software 202 may be started through manual activation on the ND 53 or the VCS 1. Alternatively, the software may be started at key-on or when the vehicle is started.

In order to identify the vehicle occupants, the vehicle occupants may provide identifying information (block 402). The identifying information may include, but is not limited to, matching or corresponding identifying information to one or more of the identifying information stored in the occupant profile 210 (described above). Accordingly, the vehicle occupant(s) may input the identifying information which may be compared to the identifying information in the occupant profile 210. Based on a match or a correspondence between the items, the vehicle occupant(s) may be identified. In this context, input may include pairing a nomadic device and/or manual input by the vehicle occupant(s).

It is not necessary that vehicle occupants identify themselves or even be in the vehicle to be identified. For example, a vehicle occupant may identify other vehicle occupants by selecting from a contact list. The contact list may be stored on the occupant's ND 53, on a portable memory device, or stored remotely (e.g., at an Internet-accessible computing system).

In some embodiments, vehicle occupants may be identified based on an electronic mail address. A vehicle occupant may select (e.g., from a list of contacts) who is (or will be) in the vehicle which may trigger an email to be sent to the contact(s). If the recipient accepts (e.g., by clicking a link), the information may be received by the occupant profile system 210 and the recipient identified based on the email address. The same process may be performed using text messaging, microblogging and/or other forms of like communications.

After a certain time period (e.g., based on minutes, hours, days, or variations thereof), if the one or more other vehicle occupants are not confirmed as being in the vehicle (based on self-identification), the implemented shared preferences may be removed.

Referring now to block 404, based on the identifying information, the software 202 may determine the number of vehicle occupants present in the vehicle. The software 202 may implement the preferences for vehicle-based operations of any number of vehicle occupants.

In the case where a single occupant is identified (i.e., multiple occupants are not in the vehicle) (block 405), the preferences for the single occupant may be received by the software 202 from the preference information for the vehicle occupant 212 (block 406). Of course, in this context, the preferences for the single occupant may only be implemented temporarily until one or more additional occupants enter the vehicle at which point the shared preferences may be merged and implemented in the vehicle.

Not all preferences defined by the single occupant may be satisfied. For example, if the preference for one or more vehicle based operations is time-based, the single occupant may not enter the vehicle during the defined timeframe. Accordingly, the preference may not be satisfied and, therefore, the preference not implemented (block 410). In some embodiments, if the preference cannot be satisfied, the vehicle occupant may be notified. It will be appreciated that while the example uses a time-based preference, this is not the only preference that may not be satisfied. For brevity, only one example is given. As such, any defined preference may not be satisfied resulting in the preference(s) not being implemented.

As represented by block 412, if at least one preference is satisfied, the at least one preference may be implemented (block 412).

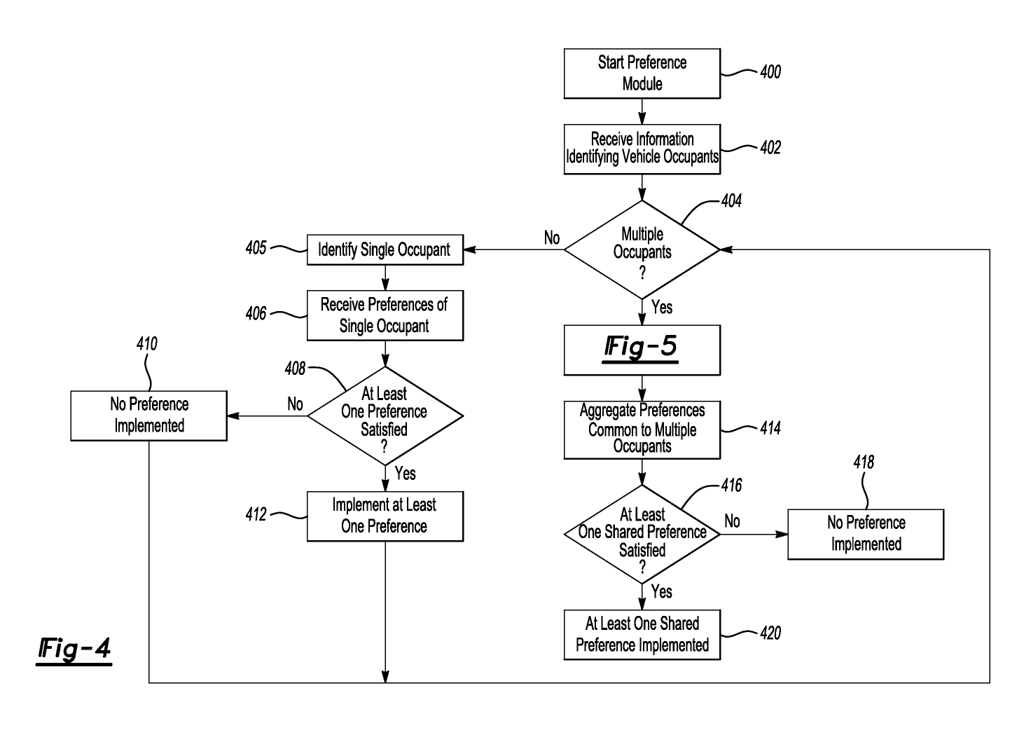

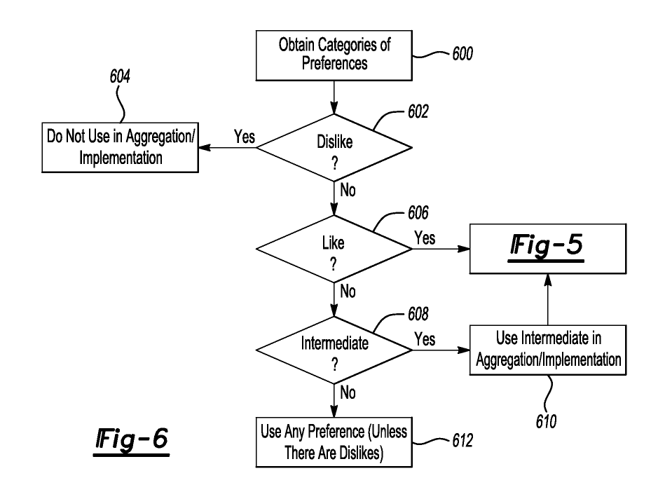

Continuing from block 404 and referring to FIG. 5, where there are two or more occupants in a vehicle, each vehicle occupant may be identified based on the occupant profile information 210 (block 500). Once each occupant is identified, the preferences of each identified occupant may be obtained (blocks 502 and 504). Of course, the preferences may be obtained in series or in parallel depending on the specific implementation of the various embodiments.

Based on the preferences for each of the two or more vehicle occupants, the software 202 may search for shared preferences between the vehicle occupants (block 506). The search may be performed based on the preferences information for each vehicle occupant at the preferences storage system 212. In some embodiments, the preferences for one vehicle occupant may be compared with the preferences for the additional vehicle occupants to determine if there are shared preferences between the vehicle occupants.

In some embodiments, the search may include a filtering process based on the levels of acceptability defined by the vehicle occupants for the vehicle-based operations. Non-limiting examples of these levels/rankings is described above. Further details of the filtering process are described with respect to FIG. 6.

With respect to the process shown in FIG. 5, the items which, for example, a vehicle occupant “dislikes,” may be identified as a non-shared preference with the other vehicle occupants (block 508). Accordingly, as represented by block 604 (FIG. 6), these items may not be used in aggregating shared preferences. In some embodiments, these low or lower level acceptability items may be flagged so that they are not used in the merging process.

It is probable that at least one vehicle occupant may not have any shared preferences with other vehicle occupants. In this case, the vehicle occupant may be excluded and the preferences of this occupant not implemented in the vehicle. In some embodiments, the excluded vehicle occupant may be notified that their preferences have not been implemented.

Where there are shared preferences between the vehicle occupants, the shared preferences may be identified (block 510). In some embodiments, a flag may be set indicating that there are shared preferences and identifying the shared preferences.

There may be multiple shared preferences between the vehicle occupants. Accordingly, the search and identification of shared preferences may repeatedly occur until all shared preferences in the preferences set for each vehicle occupant have been identified (block 512). The software 202 may search for one or more identifiers (such as a flag) indicating that the preferences set for each vehicle occupant has been entirely searched.

Referring back to FIG. 4, the shared preferences of the vehicle occupants may be aggregated by the software 202 (block 414). Based on the aggregated information, commands may be generated for implementing the preferences for all the vehicle occupants.

In some embodiments (as illustrated in FIG. 4), a determination may be made if at least one shared preference has been satisfied (block 416). Not all shared preferences may be satisfied. For example, if the preference for one or more vehicle-based operations is time-based, the multiple occupants may not enter the vehicle during the defined timeframe. Accordingly, the preference may not be satisfied and, therefore, the preference not implemented (block 418). In some embodiments, if the preference cannot be satisfied, the vehicle occupants may be notified. It will be appreciated that while the example uses a time-based preference, this is not the only preference that may not be satisfied. For brevity, only one example is given. As such, any defined preference may not be satisfied resulting in the preference(s) not being implemented.

As represented by block 420, the at least one preference may be implemented in the vehicle. In some embodiments, the at least one preference may be implemented if at least one shared preference is satisfied (block 420).

In some embodiments, when preferences are implemented, further action may be required by the one or more vehicle occupants. For example, and without limitation, the vehicle occupants may be presented with possible navigation routes or POI's based on the implemented preferences. A vehicle occupant may still be required to choose the route or the POI.

In some embodiments, the software 202 may be used to arrange a carpool. For example, a vehicle occupant may manually identify potential carpool candidates from his or her contacts. If the selected candidate(s) have preferences set, including preferences for scheduled arrival and/or departure and preferred travel route, the shared preferences may be presented to the vehicle occupant. The vehicle occupant may then generate a carpool by, for example, contacting the carpool candidates.

In some embodiments, the software 202 may include an option to search for all contacts sharing one or more preferences with the vehicle occupant. For example, and without limitation, the vehicle occupant may request a search for any contacts travelling a certain route at a certain time. The results may be presented to the vehicle occupant, with which the occupant may, for example, generate a carpool.

Referring now to FIG. 6, the preferences may be based on levels of acceptability to the vehicle occupant. In some embodiments, the acceptability level assigned to a vehicle-based operation in the preference profile 212 may be used to filter out low or lower ranking vehicle-based operations during the preference search process described above (e.g., and without limitation, where the preferences include a “dislike” for particular vehicle-based operations). While FIG. 6 uses the nomenclature of “dislike,” “like,” and “tolerate,” these are provided as examples and for purposes of illustration. Other non-limiting examples of acceptability designations are described above.

Instructions may be provided from the software 202 to obtain the preference categories (block 600). These categories may be stored in the preference information storage system 212.

As described above, preferences associated with a dislike designation (block 602) may not be used in aggregating shared preferences nor used in implementing shared preferences (block 604) for all occupants. With respect to a single occupant, the vehicle-based operations associated with this acceptability ranking may not be implemented (block 604).

Those vehicle-based operations associated with a “like” designation (block 606) are, of course, aggregated and/or implemented. The aggregation/implementation process is described above.

Further, there may be vehicle-based operations associated with an intermediate designation such as, without limitation, “tolerated” (e.g., a vehicle-based operation, such as, and without limitation, a media genre, a navigation route, a cabin climate temperature, etc. is neither liked nor disliked) (block 608). In this case, these preferences may be used in preference aggregation/implementation (block 610) as the vehicle occupant, presumably, would not mind such a preference being implemented.

In some embodiments, certain vehicle-based operations may not be associated with an acceptability designation. In this case, these vehicle-based operations may be assumed to be associated with an intermediate designation and, therefore, used in the preference aggregation/implementation (block 612).

It may be that, in some instances, a vehicle occupant may not assign any levels of acceptability. Alternatively, the occupant may only assign a low level of acceptability (e.g., what is disliked). In this case, whichever vehicle-based operations are available for each vehicle occupant may be used in the preference aggregation/implementation unless any are associated with a low acceptability (e.g., designated as disliked) (block 612).

While exemplary embodiments are illustrated and described above, it is not intended that these embodiments illustrate and describe all possibilities. Rather, the words used in the specification are words of description rather than limitation, and it is understood that various changes may be made without departing from the spirit and scope of the invention.

What is claimed is:

1. A computer system for providing shared preferences between vehicle occupants for vehicle-based operations in a vehicle, the system comprising:
at least one vehicle-based computer configured to:
receive information identifying two or more occupants in a vehicle, each occupant having one or more preferences relating to a plurality of vehicle-based operations;
identify the two or more occupants in a vehicle;
receive one or more common preferences between the two or more vehicle occupants relating to the plurality of vehicle-based operations, wherein the common preferences are identified based on a search of one or more data storage systems storing the preferences for each vehicle occupant; and
implement the one or more identified common preferences in the vehicle.

2. The computer system of claim 1 wherein the vehicle-based computer is further configured to merge the one or more common preferences between the two or more vehicle occupants for implementation in the vehicle.

3. The computer system of claim 1 wherein information identifying two or more occupants in a vehicle include at least one of a mobile identification number (MIN), a name, a fingerprint, a voiceprint, a unique keyphrase, a unique code, a unique graphic, an electronic mail address, or a combination thereof.

4. The computer system of claim 1 wherein the one or more data storage systems storing the preferences for each vehicle occupant further store a level of acceptability for the vehicle-based operations for each vehicle occupant.

5. The computer system of claim 4 where the at least one vehicle-based computer is further configured to:
filter the preferences for each vehicle occupant for the vehicle-based operations based on the level of acceptability to obtain a filtered set of preferences for the vehicle-based operations; and
identify the common preferences based on the filtered set.

6. The computer system of claim 4 wherein the at least one vehicle-based computer is configured to identify one or more unfavorably ranked vehicle-based operations, wherein the unfavorably ranked vehicle-based operations are excluded from implementation in the vehicle.

7. The computer system of claim of claim 1 wherein the vehicle-based operations include at least one of navigation routes, points-of-interest (POI), HVAC settings, media genres, media artists, radio stations, vehicle speed, news sources, traffic sources, sources of RSS feeds, cabin lighting, time of arrival, and time of departure.

8. The computer system of claim 1 wherein the at least vehicle-based computer configured to implement the one or more common preferences is further configured to:
determine that at least one common preference is satisfied; and
implement the one or more common preferences in the vehicle that are satisfied.

9. A computer-program product for providing in a vehicle shared preferences between vehicle occupants for vehicle-based operations, the computer-program product executing on a computer-readable medium and including instructions for:
receiving information identifying a number of occupants in a vehicle, each occupant having one or more preferences relating to a plurality of vehicle-based operations;
based on the identified number of occupants, identifying the preferences relating to the plurality of vehicle-based operations for a single occupant or a plurality of occupants;
if a single occupant, receiving the preferences for the single occupant;
if a plurality of occupants, receiving one or more common preferences between the plurality of vehicle occupants relating to the plurality of vehicle-based operations; and
preparing the one or more identified preferences for implementation at one or more vehicle-based systems.

10. The computer-program product of claim 9 wherein the instructions for preparing include instructions for merging the one or more common preferences between the two or more vehicle occupants for implementation in the vehicle.

11. The computer-program product of claim 9 further comprising instructions for implementing the one or more identified preference at the one or more vehicle-based systems.

12. The computer-program product of claim 9 wherein information identifying a number of occupants in a vehicle include at least one of a mobile identification number (MIN), a name, a fingerprint, a voiceprint, a unique keyphrase, a unique code, a unique graphic, an electronic mail address, or a combination thereof.

13. The computer-program product of claim 9 wherein at least some of the preferences are based on time, weather, or both.

14. The computer-program product of claim 9 further comprising instructions for:
monitoring for confirmation that at least two occupants comprising the plurality of occupants are present in the vehicle; and
preparing the one or more identified preferences at the one or more vehicle-based systems for implementation for the plurality of occupants that are confirmed.

15. The computer-program product of claim 14 further comprising instructions for:
monitoring a passage of time based on a defined time period within which to receive the confirmation; and
preparing the one or more identified preferences for implementation if the confirmation is received within the time period.

16. The computer-program product of claim 9 further comprising instructions for determining a change in the number of occupants based on the identifying information.

17. A method comprising:
receiving information at one or more computers that two or more occupants are in a vehicle;
receiving at the computer(s) preferences relating to a plurality of vehicle-based operations for each vehicle occupant;
determining at the computer(s) a presence of common preferences between each occupant relating to the plurality of vehicle-based operations;
identifying the common preferences; and
preparing the identified common preferences for implementation in the vehicle.

18. The method of claim 17 wherein preparing the identified common preferences includes merging each preference for the first occupant that is common with a preference for the second occupant.

19. The method of claim 17 further comprising implementing the one or more identified preference at the one or more vehicle-based systems.

20. The method of claim 17 further comprising:
presenting the identified common preferences in the vehicle;
receiving a selection of at least one common preference for implementation in the vehicle; and
implementing the at least one selected common preference.
